(19) United States
(12) Patent Application Publication
(10) Pub. No.: US 2020/0167733 A1
(43) Pub. Date: May 28, 2020

(54) A NODE AND METHOD FOR STAGE PRODUCTION MANAGEMENT

(71) Applicant: DISGUISE TECHNOLOGIES LIMITED, Greater London (GB)

(72) Inventor: Ashraf Nehru, London (GB)

(21) Appl. No.: 16/332,534

(22) PCT Filed: Sep. 11, 2017
(86) PCT No.: PCT/GB2017/052654

§ 371 Date: Mar. 12, 2019

(30) Foreign Application Priority Data
Sep. 12, 2016 (GB) 1615482.5

(51) Int. Cl. G06Q 10/10; G06F 16/25

(52) U.S. Cl. CPC G06Q 10/103; G06F 16/258

(57) ABSTRACT

Example embodiments described herein relate to a digital stage production management system where multiple stage components may participate in a stage production may provide stage production related operations with an associate time. A coordination of multiple stage productions is provided with respect to the associate time such that different stage components may simultaneous participate in the stage production.

Example embodiments described herein relate to a digital stage production management system where multiple stage components may participate in a stage production may provide stage production related operations with an associated time. A coordination of multiple stage operations is provided with respect to the associated time such that different stage components may simultaneous participate in the creation of the stage production.

### BACKGROUND

Digital media design and production merges the world of stage production with modern digital media creation technologies. With the use of digital media design, typical stage production operations, such as lighting, choreography, prop or object placement, etc., may be designed, planned and/or previewed digitally. Digital stage production typically takes place with a team of multiple people working together. Different people may work on different aspects of the stage production.

### BRIEF SUMMARY

Often, different users or stage production components work on different aspects of the production. For example, a team may be dedicated to the lighting of the stage production, while a different team may be dedicated to the choreography of the actors of the stage production. While both of these teams may work independently to some extent, these team rely on information from one another in order to work optimally. Specifically, if the choreography of the stage production is altered, this information must be relayed to the lighting design team in order to ensure the actors are properly illuminated. Therefore, it is useful to provide such changes or updates in real-time.

As a result, in current systems, it is often needed for such teams to work in the same environment or room in order to reflex any changes to the stage production in real time. However, modern stage production teams feature members of the team in various physical locations and different time zones which makes such real time updating difficult.

As such, at least one example object of some of the example embodiments described herein is provide an efficient and effective means of providing digital stage production management. At least one example advantage of such a system is to decoupling of various teams such that the teams no longer need to be in the same environment or in the same time zone in order to obtain real time updates. A further example advantage is the coordination of data, related to digital stage production management, from multiple users. Thus, an efficient manner of providing a digital stage production management system is provided herein where users may be situated in different locations and/or time zones.

Accordingly, some example embodiments are directed towards an apparatus for stage production management. The apparatus comprises a network interface to receive stage component production data from at least one stage component management system. The at least one stage component management system is one among a plurality of stage component management systems in a stage production project. The stage component production data is representative of a performance of the plurality of stage components in a stage production project. At least two of the stage component management systems relate to a different operation of the stage production project.

The apparatus further comprises a memory unit and one or more processing units to store in the memory unit received stage component production data from the at least one stage component management system, of the plurality of stage component management systems, where each of the received component production data comprises an operation of the stage production project and an associated time in which the operation is to occur. The one or more processing units is further to coordinate all received stage component production data with respect to a timeline of the stage production.

Such embodiments comprise the example advantage of allowing for users of different stage component management systems to simultaneously work together, regardless of physical location, to make work on a stage production in an efficient an organized manner.

Some of the example embodiments are directed towards a centralized stage component management system for stage production. The centralized stage component management system for stage production comprises a network interface to receive stage operation data from at least one local stage component management system, of a plurality of local stage component management systems. The stage operation data is representative of a performance of a stage production project.

The centralized system further comprises a memory unit and one or more processing units to generate a plurality of simulated digital stage environments for a respective local stage component management system. Each local stage component management system is located in a respective location. The memory unit and one or more processors is further configured to store in the memory unit stage operation data from the respective local stage component management systems. Different stage operation data from at least two different respective local stage component management systems relate to a different respective aspect of the stage production. The memory unit and one or more processors is further configured to implement production changes in a centralized simulated digital stage environment as a result of the received stage operation data and update the plurality of simulated digital stage environments as a result of the implemented production changes.

Some of the example embodiments are directed towards a local stage component management system for stage production management. The local stage component system comprises a memory unit and one or more processing units to process a simulated digital stage environment received from a centralized stage component management system. The memory unit and one or more processing units is further configured to generate stage operation data related to a production change in the simulated digital stage environment. The memory unit and one or more processing units is also configured to send the generated stage operation data to the centralized stage component management system. The memory unit and one or more processing units is also configured to process an updated simulated digital stage environment received from the centralized stage component management system. The updated simulated digital stage environment comprises the production change and at least one other production change from another respective local stage component management system.

Such example embodiments are directed towards a centralized system in which a central stage component management system may organize and implement change proposed by multiple local stage component management systems in the production system. Such example embodiments comprise the example advantage of providing a streamlined approach to implementing changes of the various local stage component management system. Furthermore, such example embodiments lessen the complexity of the local stage component management systems as the local systems do not have to coordinate stage operation data from other local systems.

It should be appreciated that some of the example embodiments are directed towards a distributed system where each of the local stage component management systems may update each of the other local stage component management systems. Such example embodiments provide the example advantage of eliminating the need of an additional central node thereby reducing the number of nodes in the system.

Some of the example embodiments are directed towards a computer-readable medium comprising executable instructions such that when executed by a centralized stage component management system provides stage production management. The instructions provide the centralized system to generate a plurality of simulated digital stage environments for a plurality of local stage component management systems, respectively. The instructions further provide the centralized system to process stage operation data received from the respective local stage component management systems. At least two stage operation data from at least two different respective local stage component management systems relate to different aspects of the stage production. The instructions further provide the centralized system to implement production changes in a centralized simulated digital stage environment as a result of the received stage operation data. The instructions also provide the centralized system to update the plurality of simulated digital stage environments as a result of the implemented production changes.

Some of the example embodiments are directed towards a computer-readable medium comprising executable instructions such that when executed by a local stage component management system provide stage production management. The instructions provide the local system to process a simulated digital stage environment received from a centralized stage component management system. The instructions further provide the local system to generate stage operation data related to a production change in the simulated digital stage environment. The instructions further provide the local system to send the generated stage operation data to the centralized stage component management system. The instructions also provide the local system to process an updated simulated digital stage environment received from the centralized stage component management system. The updated simulated digital stage environment comprises the production change and at least one other production change from another respective local stage component management system.

Example embodiments are further directed towards a centralized stage component system substantially as herein described, with reference to the accompanying drawings. Example embodiments are also directed towards a local stage component management system substantially as herein described, with reference to the accompanying drawings. Example embodiments are further directed towards a stage component management system as herein described, with reference to the accompanying drawings. Example embodiments are also described to a stage production management system as herein described, with reference to the accompanying drawings.

### BRIEF DESCRIPTION OF THE DRAWINGS

The foregoing will be apparent from the following more particular description of the example embodiments, as illustrated in the accompanying drawings in which like reference characters refer to the same parts throughout the different views. The drawings are not necessarily to scale, emphasis instead being placed upon illustrating the example embodiments.

FIG. 1 is an example of a centralized system orientation of stage production management, according to some of the example embodiments;

FIG. 2 is an example of a distributed system orientation of stage production management, according to some of the example embodiments;

FIG. 3 is an illustrative example of timeline based recordation of stage operation data, according to some of the example embodiments;

FIG. 4 is an example node configuration of a stage component management system featured in FIGS. 1 and 2, according to some of the example embodiments; and

FIGS. 5-7 are flow diagrams depicting example operations which may be performed by the stage component management system of FIGS. 1, 2 and 4, according to some of the example embodiments.

### DETAILED DESCRIPTION

In the following description, for the purposes of explanation and not limitation, specific details are set forth, such as particular components, elements, techniques, etc. in order to provide a thorough understanding of the example embodiments. However, the example embodiments may be practiced in other manners that depart from these specific details. In other instances, detailed descriptions of well-known methods and elements are omitted so as not to obscure the description of the example embodiments.

Often, different users, working via stage production components, work on different aspects of a stage production. Creating a stage show requires the close co-operation of a number of disciplines, for example, lighting, audio, video/projection, scenic movement, choreography, and potentially robotics, pyrotechnics and fountains. Each department not only has to design its responses to the major show cues, but must coordinate with all other departments in order to realise the vision of the show designers and directors.

One reason for the difficulty of this process is that all departments have to share a single stage, with usually only one department having control of the stage at any one time in order to solve problems or hone their work. Departments will prepare as much as possible in their own spaces away from the stage, but for the show to come together, all departments must perform correctly at the same time.

Simulation and 3D Visualisation are two technologies that have gained a great deal of popularity in recent years, as they allow production professionals in all departments to work with a virtual stage, thus allowing them to work in advance of arriving at the physical stage, and to work in parallel with each other. However, this still requires that all departments be connected to a visualizer, or stage component management, system at the same time in order for the designer to be able to view the whole show. This creates the same coordination problem as on a physical stage; only one department at a time can work to modify and improve their show at a time, and the others have to wait or play along.

As such, at least one example object of some of the example embodiments described herein is provide an efficient and effective means of providing digital stage production management. At least one example advantage of such a system is to decoupling of various teams such that the teams no longer need to be in the same environment or in the same time zone in order to obtain real time updates. A further example advantage is the coordination of data, related to digital stage production management, from multiple users. Thus, an efficient manner of providing a digital stage production management system is provided herein where users may be situated in different locations and/or time zones.

Example embodiments presented herein provide a modification to a stage visualisation, or component management system that breaks this dependency, allowing all departments to work in parallel with each other, to their own schedules, while still remaining coordinated. It thus has strong economic benefits for the stage, theatre and entertainment industries, as it has the potential to drastically reduce the on-site pre-production and rehearsal time required to produce a show.

According to some of the example embodiments, in order to visualise their show, a given department, or stage component management system, sends a stream of control signals to a visualisation computer, which renders appropriately to give the designer a clear idea of how the show will look when those same control signals are sent to physical devices on stage. A lighting visualiser, for example, will receive Artnet control packets and use the data to control the colour, brightness and direction of virtual spotlights, visualising the effect of the beam in the atmosphere and on surfaces on stage. A video visualiser will receive a 2-dimensional video stream and map it onto a 3-dimensional surface, showing the designer how it will look on the final stage. The same applies to all other show departments.

According to some of the example embodiments, the visualiser, or stage component management system, is given the ability to record the information streams coming from each department onto a timeline, and then play these streams back on command. This allows the designer to visualise that portion of the show even when the particular device (such as the media server or lighting desk) is disconnected, or in a remote location.

According to some of the example embodiments, each department manages one or more visualiser computers of their own, work freely to their own schedule. Once they are satisfied with their changes, they record the results onto the visualiser's timeline. This recording may be transferred to a central ‘master’ visualiser, which then distributes it to all other departments' visualiser machines. All departments are thus able to keep up to date with changes made by all other departments, and are able to view the entire show without having to be in the same physical location. This allows coordination issues to be identified and resolved as soon as they occur, long before the production process transfers to the physical space.

It should be appreciated that the example embodiment presented herein may also be applied to a distributed system orientation, which does not utilize a central visualizer. It should further be appreciated that the example embodiments may be applied to a distributed system which makes use of a dynamic or static master-slave arrangement with other stage component management systems.

The example embodiments are further described below. First, a discussion on a system overview and different system configurations is provided under the subheading ‘System Orientation’. Thereafter, a detailed discussion on how stage operation data is coordinated and saved is provided under the subheading ‘Timeline based Recordation’. Thereafter, an example hardware configuration of a stage component management system and example operations of such a system is provided under the subheadings ‘Example component configuration’ and ‘Example Operations’, respectively. It should be appreciated that the various embodiments discussed herein and under the different subheadings may be used in conjunction with one another in any combination.

System Orientation

According to some of the example embodiments, the digital stage management production system may be orientated in a centralized, distributed, or a combined centralized and distributed based configuration. Examples of such systems are provided herein.

Centralized System Configuration

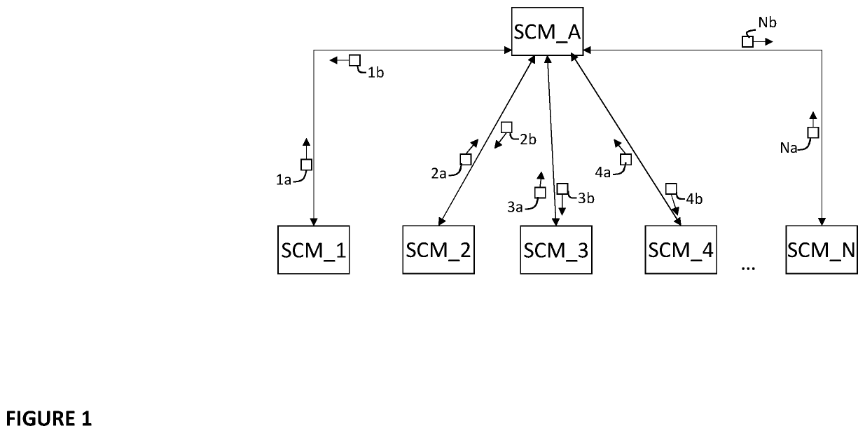

FIG. 1 illustrates an example system overview of some of the example embodiments presented herein. The example provided in FIG. 1 is a centralized management system. Different production teams may utilize respective stage component management systems SCM_1-SCM_N. For example, a lighting team may utilize stage component management system SCM_1 and SCM_2, while a chorography team utilizes stage component management system SCM_4. It should be appreciated that the stage component management systems SCM_1-SCM_N may be situated in any physical location and in any time zone. The centralized system of FIG. 1 may further comprise a central stage component management system SCM_A. The central stage component management system SCM_A may be in bilateral communications with each of the stage component management systems SCM_1-SCM_N. Such bilateral communications may be wireless, wired, internet or cloud based communications.

According to some of the example embodiments, each stage component management systems SCM_1-SCM_N may be provided with a simulated virtual representation of the stage in which the production is to take place. Utilizing this representation, a user from the team may submit stage production operations via a displayed user interface provided by a hardware module of the stage component management system. A team member may preview the effect of the stage production operation via the virtual representation. For example, a team member utilizing the stage component management system SCM_1 may enter a stage production operation providing a lighting effect on the stage. By entering such an operation, the corresponding lighting effect may be previewed on the virtual representation prior to the operation being implemented or submitted to the central stage component management system.

According to some of the example embodiments, if the team member wishes to implement such an operation, the stage production operation may be submitted to the central stage component management system SCM_A. Specifically, the stage component management systems SCM_1-SCM_N may be configured to send stage production operation data 1a-Na, respectively, to the central stage component management system SCM_A. According to some of the example embodiments, the stage production operation information may comprise an operation to be performed in the stage performance as well as a corresponding time stamp or time value indicting a cue within which the action should be performed, as well as the time within that cue at which it should be performed.

According to some of the example embodiments, the stage component management systems SCM_1-SCM_N may be configured to send the stage operation data 1a-Na in real time as soon as such a change is input by a respective team of the component management system. According to some of the example embodiments, the stage component management systems SCM_1-SCM_N may be configured to work ‘offline’ such that any number of changed may be input into the stage component management system while the system is not in connected communications with the central stage component management system SCM_A. Once the stage component management system is again in connected communications with the central stage component management system, the stage operation data may be transmitted to the central stage component management system.

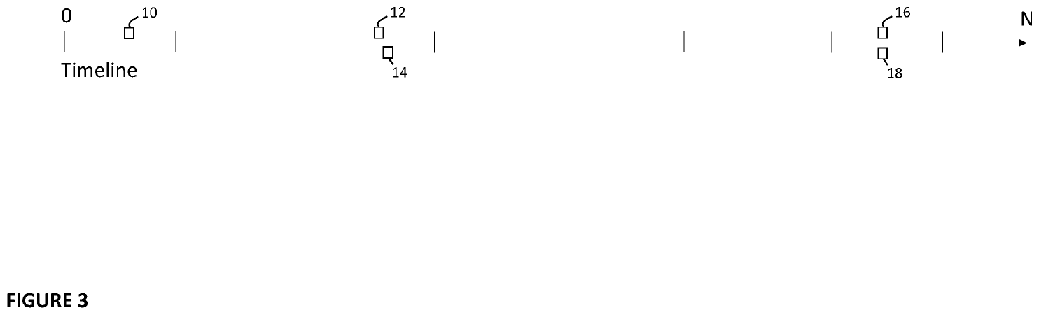

The central stage component management system SCM_A may process the stage operation data 1a-Na received via respective stage component management systems SCM_1-SCM_N. In such processing, the may coordinate all the operations with respect to a timeline of the stage production. Such, coordination may be referred to as timeline storage which will be discussed further in relation to FIG. 3. The central stage component management system SCM_A may thereafter update each of the respective stage component management systems SCM_1-SCM_N by sending updated stage component data 1b-Nb, respectively.

According to some of the example embodiments, the stage component data 1b-Nb may be in the form of an updated simulated virtual representation of the stage featuring all operations, at corresponding times, as provided for in the stage operation data 1a-Na. According to some of the example embodiments, the stage component data 1b-Nb may be in the form of a list of updates provided for in the stage operation data 1a-Na. According to such embodiments, each individual stage component management systems SCM_1-SCM_N may update their own virtual representation according to the stage component data 1b-Nb.

According to some of the example embodiments, the transmission of stage component data 1b-Nb may occur in real time. Specifically, once any of the stage component management systems SCM_1-SCM_N sends stage operation data 1a-Na to the central stage component management system SCM_A, the central stage component management system may in turn process such information and immediately send stage component data 1b-Nb to all of the stage component management systems SCM_1-SCM_N such that each component systems has the latest updates with respect to the stage production.

According to some of the example embodiments, the stage component management systems SCM_1-SCM_N and/or the central stage component management system SCM_A may comprise a video display that may be configured to playback a preview of all current operations of the stage production. Such a playback feature may be provided using the simulated virtual stage representation.

Distributed System Configuration

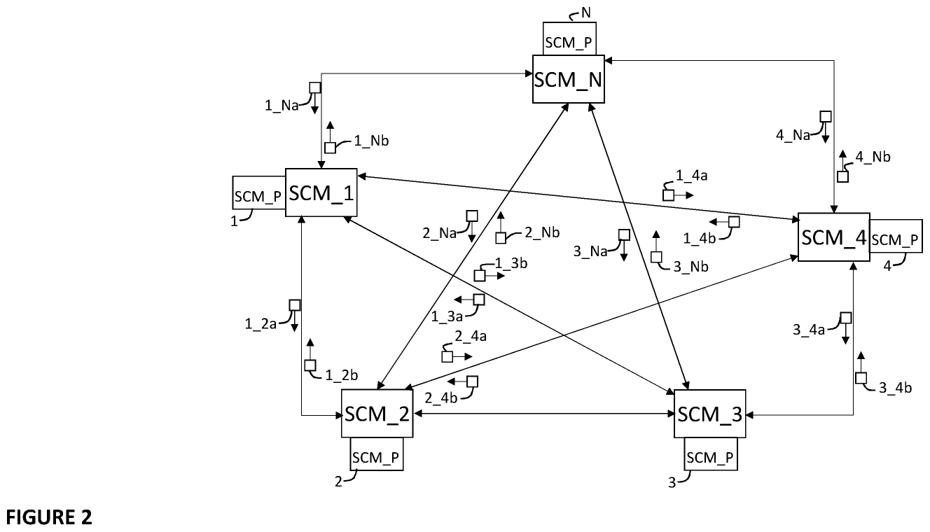

FIG. 2 illustrates an example overview of a distributed system configuration. The distributed system configuration comprises many of the same components of the centralized system of FIG. 1. In contrast to FIG. 1, the distributed system of FIG. 2 does not comprise a single centralized central stage component management system SCM_A. Instead, each of the stage component management systems SCM_1-SCM_N is in direct bilateral communications with each other.

Furthermore, according to some of the example embodiments, each of the stage component management systems SCM_1-SCM_N may comprise a processing stage component SCM_P 1-N, respectively, which may perform the similar functionality to that of the central stage component management system SCM_A. Specifically, the processing stage component SCM_P 1-N may receive and process incoming stage operation data 1_2a-4_Na from other stage component management systems SCM_1-SCM_N. Similarly, each stage component management system SCM_1-SCM_N may generate stage operation data, as described above under the subheading ‘Centralized System Configuration’, and send such outgoing data 1_2b-4_Nb to each of the other stage component management systems SCM_1-SCM_N.

According to some of the example embodiments, each respective processing stage component 1-N may provide timeline storing in a similar manner as the central stage component management system SCM_A of FIG. 1. Specifically, each individual processing stage component 1-N may store incoming 1_2a-4_Na and outgoing 1_2b-4_Nb stage operations according to a timeline of the stage production for a respective stage component management system SCM_1-SCM_N. Furthermore, according to some of the example embodiments, each processing stage component 1-N may assist in maintaining the simulated virtual stage representation for a respective stage component management system SCM_1-SCM_N.

Combined Centralized and Disturbed based Configuration

According to some of the example embodiments, a combined centralized and disturbed based configuration may be employed. According to such embodiments, in the distributed based system of FIG. 2, one of the stage component management systems SCM_1-SCM_N may be designated as a master node and the remaining stage component management systems may be designated as slave nodes. In such a configuration, the master node may function in a manner similar to the central stage component management system SCM_A of FIG. 1.

Specifically, all of the stage component management systems SCM_1-SCM_N which are designated as slave nodes may send incoming stage operation data 1_2a-4_Na to the stage component management system which is designated as the master node. The stage component management system designated as the master node may provide a coordination of the stage operation data and a time storing. The master stage component management system SCM_1-SCM_N may thereafter send outgoing stage operation data 1_2b-4_Nb to the slave stage component management systems SCM_1-SCM_N. It should be appreciated that the designation of the master and slave nodes may be static or dynamic.

Timeline based Recordation

FIG. 3 illustrates an example of a timeline based recording of stage operation data. The stage operation data may come in different forms depending on what aspect of the stage production the information is associated with. The stage operation data may also comprise a corresponding time stamp providing a time within the stage production that the operation is to take place.

Example forms of stage operation data is provided in the list below. It should be appreciated that the list is merely an example and other forms of stage operation data may be used in conjunction with the example embodiments.

Lighting: Lighting stage operation data may comprise Digital Multiplex (DMX) data communicated, for example, via physical RS232 or via Ethernet (the ArtNet protocol). Such lighting information may also be communicated via Streaming Architecture for Control Networks (sACN) and/or a range of proprietary Ethernet based protocols such as KiNet, Wendi and so on.

Audio: Audio stage operation data may be transferred over physical analogue lines (phono/jack), or via digital means (e.g., Sony/Philips Digital Interface Format (SPDIF)), or via Ethernet (e.g., Dante protocol).

Video: Video stage operation data may comprise signals from stage cameras, usually transmitted via Serial Digital Interface (SDI) over coax cable, but also available via Ethernet (e.g., Basler network protocol, Network Device Interface (NDI), Spout, etc.).

Tracking: Tracking stage operation data may comprise infrared Light Emitting Diode (LED) markers tracked via cameras, including the BlackTrax Real-Time Trajectory Path Modification (RTTPM) protocol, and the open PosiStageNet tracking protocol. These may be carried by Ethernet User Datagram Protocol (UDP) packets.

Automation/Motion Control: Automation/Motion control stage operation data may comprise a multitude of data protocols, with each proprietary to the maker of the motion system used. Examples of such data include Fisher Navigator, Kinesys, StageTech, and so on.

Musical Performance: Musical performance stage operation data may comprise musical and synthesizer controls are often carried by a Musical Instrument Digital Interface (MIDI) or by its successor, Open Sound Control (OSC) which may be carried via UDP packets.

Control Signals: Control signal stage operation data may comprise controls for a variety of devices such as projector settings, projector shutters, and/or moving head cameras. Such control information may be generated by external devices, recorded and replayed. These are usually represented as control strings transmitted via UDP or telnet.

Stage operation data, for example as described above, may be generated and transmitted from the various stage component management systems SCM_1-SCM_N and the central stage component management system SCM_A of FIGS. 1 and 2. The central stage component management system SCM_A and/or the stage component management systems SCM_1-SCM_N may store such information in the form of a timeline as illustrated in FIG. 3.

FIG. 3 illustrates various forms of stage operation data 10-18 stored within the timeline. The stage operation data may comprise operation data, for example as explained above, in addition to a time stamp. According to some of the example embodiments, the time stamp may provide an indication of when a cue for an action associated with the stage operation data is to take place. As illustrated in FIG. 3, the stage operation data labelled 10 comprises a time stamp indicating an action to occur at an earlier time in the stage production than that of stage operation data 12. Therefore, stage operation data 10 appears in the time line recording prior to the stage operation data 12.

According to some of the example embodiments, stage operation data from different stage component management systems SCM_1-SCM_N may be provided such that different stage operation data may not occur simultaneously. For example, assume stage operation data 12 indicates a prop to be placed within a certain time and location and stage operation data 14 indicates a piece of chorography which is to take place in a same location and in a same time proximity where the prop will interfere with the choreography. In such an instance, the stage component management system SCM_1-SCM_N or the central stage component management system SCM_A may send a warning to the two stage component management systems associated with the stage operation data 12 and 14 in order to resolve the conflict.

Example Component Configuration

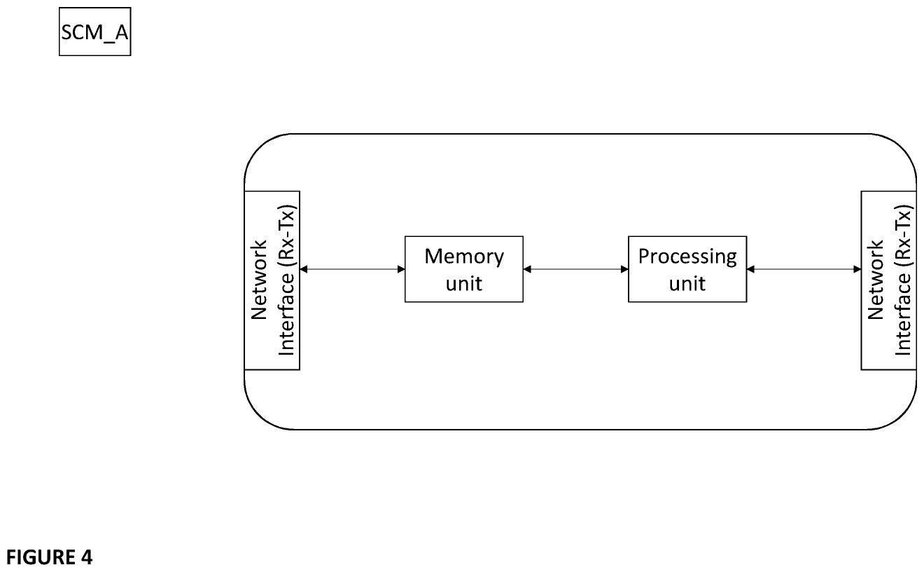

FIG. 4 illustrates an example component configuration of a stage component management systems SCM_1-SCM_N, a central stage component management system SCM_A, and/or a processing stage component SCM_P1-N. The component of FIG. 4 may comprise any number of network interfaces which may be configured to receive and transmit any form of stage operation data or timeline recording information as described herein. According to some of the example embodiments, the network interface may also comprise a single transceiving interface or any number of receiving and/or transmitting interfaces.

The component of FIG. 4 may further comprise at least one memory that may be in communication with the network interfaces. The memory may store received or transmitted data and/or executable program instructions. The memory may also store information relating to stage operation data or the timeline recording for a stage production. The memory may be any suitable type of machine readable medium and may be of a volatile and/or non-volatile type.

The component of FIG. 4 may also comprise at least one processing unit which may be configured to process received information related to the stage production. The processing unit may also be configured to maintain the timeline recording as well as generate any messaging related to the stage production or stage operation data. The processing unit may be any suitable computation logic, for example, a microprocessor, digital signal processor (DSP), field programmable gate array (FPGA), or application specific integrated circuity (ASIC) or any other form of circuitry.

Example Operations

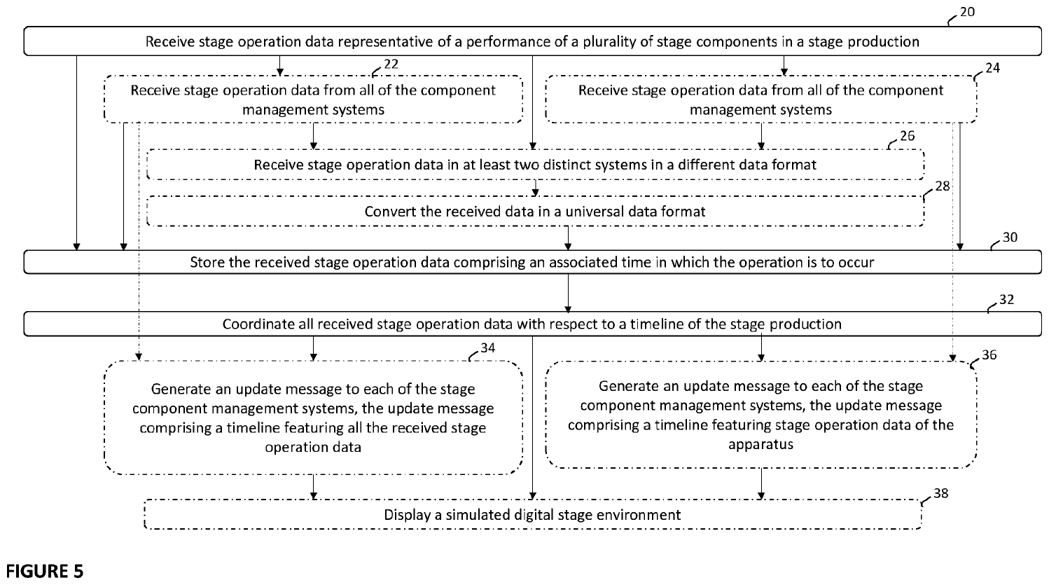

FIG. 5 illustrates a flow diagram depicting example operations which may be taken by the component of FIG. 4 in both the centralized based system of FIG. 1 and the distributed system of FIG. 2 for stage production management as described herein.

It should be appreciated that FIG. 5 comprises some operations which are illustrated in a solid border and some operations which are illustrated with a dashed boarder. The operations which are comprised in a solid border are operations which are comprised in the broadest example embodiment. The operations which are comprised in a dashed boarder are example embodiments which may be comprised in, or a part of, or are further operations which may be taken in addition to the operations of the boarder example embodiments. It should be appreciated that these operations need not be performed in order. Furthermore, it should be appreciated that not all the operations need to be performed. The example operations may be performed in any order and in any combination.

Operation 20

The example embodiments are directed towards an apparatus for stage production management comprising receiving 20 stage operation data form at least one stage component management system, for a plurality of stage component management systems, representative of a performance of the plurality of stage components in a stage production project. At least two of the stage components relate to a different operation of the stage production project. The network interface and/or a receiving means is configured to receive the stage operation data as described herein.

Operation 20 is further described at least under the subheading ‘System Orientation’. The stage operation data may be any form of data which describes an operation or action to take place during the stage production. Such information is further described under at least the subheading ‘Timeline based Recordation’. It should be appreciated that operation 20 describes the receiving of stage operation data, where the receiving node is either a centralized node (e.g., as described in relation to FIG. 1) or one of many distributed nodes (e.g., as described in relation to FIG. 2). It should further be appreciated that the receiving node may be one of many distributed nodes in a slave-master orientation where one of the distributed nodes may be designated as a master or central node in a dynamic or static manner.

According to some of the example embodiments, the receiving may further comprise receiving the stage operation data from a cloud based or an internet based communications medium. Furthermore, according to some of the example embodiments, the centralized node may be configured to receive stage operation data which was generated while a local stage component management system was offline.

Example Operations 22 and 24

According to some of the example embodiments, the receiving 20 may further comprise receiving 22/24 stage operation data from all of the stage component management system in the stage production project. The network interface of FIG. 4 and a receiving means may be configured to receive the stage operation data as described in example operation 22.

Example operation 22 describes the centralized orientation of FIG. 1 in which the central stage component management system SCM_A receives all stage operation data 1a-Na from all the other or local stage component management systems SCM_1-SCM_N. It should be appreciated that example operation 22/24 also describes an operation of a stage component management system of FIG. 2, in functioning as a central or master node. Example operation 24 describes the operation of a local stage component management system of FIG. 2 receiving stage operation data from other local stage component management systems of the distributed network.

Example Operation 26

According to some of the example embodiments, the receiving 20 may further comprise receiving 26 stage operation data from at least two distinct stage component management systems in a different data format. The network interface of FIG. 4 and a receiving means may be configured to receive the stage operation data as described in example operation 26.

As explained under the subheading ‘System Orientation’, the different stage component management systems will be involved in different aspects of the stage production project. Thus, the different systems may be utilizing different forms of data, for example, video data, lighting data or positioning data.

Example Operation 28

According to some of the example embodiments, the receiving 20/26 may further comprise converting or storing 28 the received stage operation data in a universal data format. The one or more processing units of FIG. 4 and the converting means may be configured to convert the received stage operation data as explained in example operation 28.

As the received stage operation data may be in different data formats, as explained in example operation 26, according to some of the example embodiments, the received data may be configured to a universal format such that the data may be understood by each stage component management system. According to some of the example embodiments, the universal data form may be a digital data format, for example, data which is stored in a binary format or a block of raw bytes.

Operation 30

The example embodiments are further directed towards storing 30, in the memory unit, the received stage operation data from the at least one stage component management system, of the plurality of stage component management systems. Each of the received stage operation data comprises an operation of the stage production project and an associated time in which the operation is to occur. The storing means and the memory unit is configured to store the received data as described in operation 30.

Operation 30 is further described under at least the subheading ‘Timeline based Recordation’. As explained, each action or operation associated with the stage operation data will have a corresponding time in which the action or operation is to take place. Such a timestamp may be useful in coordinating the different stage operation data from the different stage component management systems.

Operation 32

The example embodiments are further directed towards coordinating 32 all received stage operation data with respect to a timeline of the stage production. The one or more processing units and/or a coordinating means are configured to perform operation 32.

Operation 32 is further described under at least the subheading ‘Timeline based Recordation’. Each action or operation associated with the stage operation data will have a corresponding time in which the action or operation is to take place. Such a timestamp may be used in coordinating the different stage operation data from the different stage component management systems.

Example Operation 34

According to some of the example embodiments, the coordinating 32 may further comprise generating 34 an update message to each of the stage component management systems. The update message comprises a timeline featuring all of the received stage operation data. The one or more processing units of FIG. 4 and/or the generating means may perform example operation 34.

Example operation 34 may be used in conjunction with example operation 22 described above. Example operations 22 and 34 describe embodiments in which a centralized stage component management system SCM_A is employed. Thus, according to such example embodiments, the centralized system SCM_A may receive stage operation data from all of the local nodes in the system SCM_1-SCM_N. Upon coordinating received data, the centralized system SCM_A may update all of the local nodes SCM_1-SCM_N such that all of the local stage component management systems are updated with respect to any stage production changes implemented. Example operation 34 is described at least in relation to FIG. 1.

Example Operation 36

According to some of the example embodiments, the coordinating 32 may further comprising generating 36 an update message to each of the stage component management systems. The update message may comprise a timeline featuring stage operation data of the apparatus sending the message. The one or more processing units of FIG. 4 and/or the generating means may perform example operation 36.

Example operation 36 may be used in conjunction with example operation 24 described above. Example operations 24 and 36 describe embodiments in which a distributed system, such as is illustrated in FIG. 2, is employed. Thus, according to such example embodiments, each of the local stage component management systems may receive or send stage operation data from any of the other local nodes SCM_1-SCM_N. Upon coordinating received data or implementing changes itself, a local stage component management system may update all of the other local nodes SCM_1-SCM_N in the distributed system such that all of the local stage component management systems are updated with respect to any stage production changes implemented.

Example Operation 38

According to some of the example embodiments, the apparatus may further be configured to display 38 a simulated digital stage environment of the stage production and play back at least one stage operation data with respect to the timeline. The one or more processing units of FIG. 4 and the displaying means may be configured to perform example operation 38.

As described under at least the subheading ‘System Orientation’, any of the stage component management systems, in either the centralized or distributed systems, may utilize a simulated digital stage environment. Such a simulation may be useful in previewing stage operations before actually implementing such operations in the stage production. According to some of the example embodiments, in a centralized system, the central stage component management system may be used in maintaining the simulated virtual stage environment for all of the local stage component management systems.

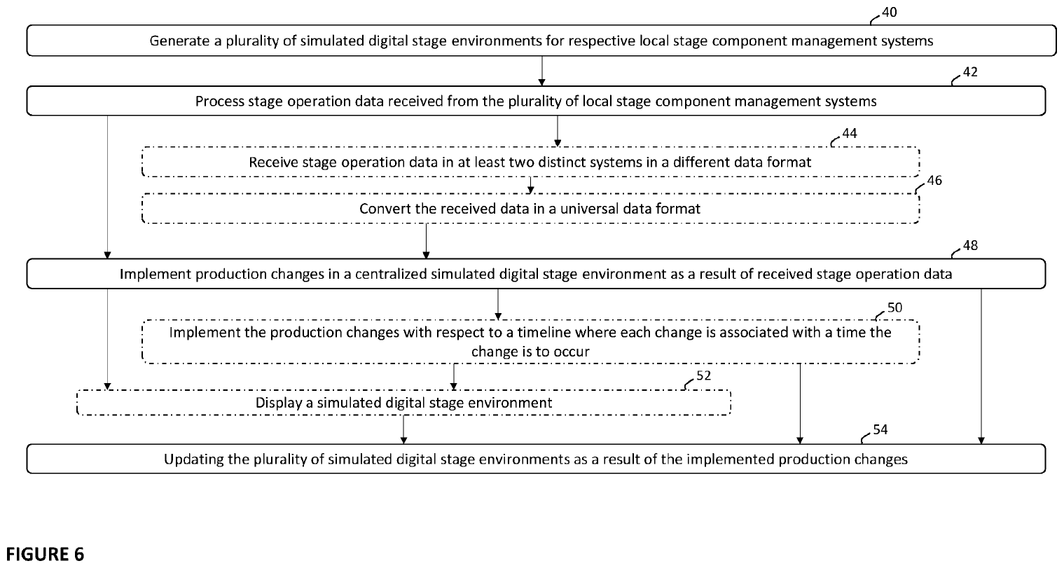

FIG. 6 illustrates a flow diagram depicting example operations which may be taken by the central stage component management system of FIGS. 1 and 4 as described herein. It should be appreciated that FIG. 6 comprises some operations which are illustrated in a solid border and some operations which are illustrated with a dashed boarder. The operations which are comprised in a solid border are operations which are comprised in the broadest example embodiment. The operations which are comprised in a dashed boarder are example embodiments which may be comprised in, or a part of, or are further operations which may be taken in addition to the operations of the boarder example embodiments. It should be appreciated that these operations need not be performed in order. Furthermore, it should be appreciated that not all the operations need to be performed. The example operations may be performed in any order and in any combination.

Operation 40

Some of the example embodiments are directed towards a central stage component management system generating 40 a plurality of simulated digital stage environments for a plurality of local stage component management systems, respectively. The one or more processing units of FIG. 4 and/or the generating means is configured to perform operation 40.

Operation 40 is further described under at least the subheading ‘System Orientation’. As described, the central stage component management system may be configured to generate and maintain a simulated digital stage environment for all of the local stage component management systems.

Operation 42

Some of the example embodiments further comprise processing 42 stage operation data received from the plurality of local stage component management systems. At least two of the local stage component management systems relate to a different aspect of the stage production project. The one or more processing units of FIG. 4 and/or the processing means is configured to perform operation 42. Operation 42 is further described under at least the subheading ‘System Orientation’.

According to some of the example embodiments, the stage operation data may be received from a cloud based or an internet based communications medium. Furthermore, according to some of the example embodiments, the centralized node may be configured to receive stage operation data which was generated while a local stage component management system was offline.

Example Operation 44

According to some of the example embodiments, the processing 42 may further comprise receiving 44 stage operation data from at least two distinct stage component management systems in a different data format. The network interface of FIG. 4 and a receiving means may be configured to receive the stage operation data as described in example operation 44.

As explained under the subheading ‘System Orientation’, the different stage component management systems will be involved in different aspects of the stage production project. Thus, the different systems may be utilizing different forms of data, for example, video data, lighting data or positioning data.

Example Operation 46

According to some of the example embodiments, the processing 42 and receiving 44 may further comprise converting or storing 46 the received stage operation data in a universal data format. The one or more processing units of FIG. 4 and the converting means may be configured to convert the received stage operation data as explained in example operation 46.

As the received stage operation data may be in different data formats, as explained in example operation 44, according to some of the example embodiments, the received data may be configured to a universal format such that the data may be understood by each stage component management system. According to some of the example embodiments, the universal data form may be a digital data format, for example, data which is stored in a binary format or a block of raw bytes.

Operation 48

Some of the example embodiments are directed towards implementing 48 production changes in a centralized simulated digital stage environment as a result of the received stage operation data. The one or more processing units of FIG. 4 and/or the implementing means may be configured to perform operation 48.

Operation 48 is further described under at least the subheading ‘System Orientation’. As described, according to some of the example embodiments, the centralized stage component management system may maintain and generate simulated digital stage environments for each of the local stage component management systems. In do so, a master or central simulated digital stage environment may be utilized.

Example Operation 50

According to some of the example embodiments, the implementing 48 may further comprise implementing 50 the production changes with respect to a timeline wherein each production change is associated with a time in which the production change is to occur. The one or more processing units and/or the implementing means may be further configured to perform operation 50.

Example operation 50 is further described under at least the subheading ‘Timeline based Recordation’. As described, each action or operation associated with the stage operation data may comprise a time in which the action or operation is to occur. Thus, all changes may be implemented with respect to the time the operation shall occur within the stage production.

Example Operation 52

According to some of the example embodiments, the centralized stage component management system may further be configured to display 52 a simulated digital stage environment of the stage production and play back at least one stage operation data with respect to the timeline. The one or more processing units of FIG. 4 and the displaying means may be configured to perform example operation 52.

As described under at least the subheading ‘System Orientation’, any of the stage component management systems, in either the centralized or distributed systems, may utilize a simulated digital stage environment. Such a simulation may be useful in previewing stage operations before actually implementing such operations in the stage production. According to some of the example embodiments, in a centralized system, the central stage component management system may be used in maintaining the simulated virtual stage environment for all of the local stage component management systems.

Operation 54

The centralized stage component management system may be further configured to update 54 the plurality of simulated digital stage environments as a result of the implemented production changes. The one or more processing units of FIG. 4 and/or the updating means may be configured to perform operation 54.

Thus, according to such example embodiments, the centralized system SCM_A may receive stage operation data from all of the local nodes in the system SCM_1-SCM_N. Upon coordinating received data, the centralized system SCM_A may update all of the local nodes SCM_1-SCM_N such that all of the local stage component management systems are updated with respect to any stage production changes implemented. Example operation 54 is described at least in relation to FIG. 1.

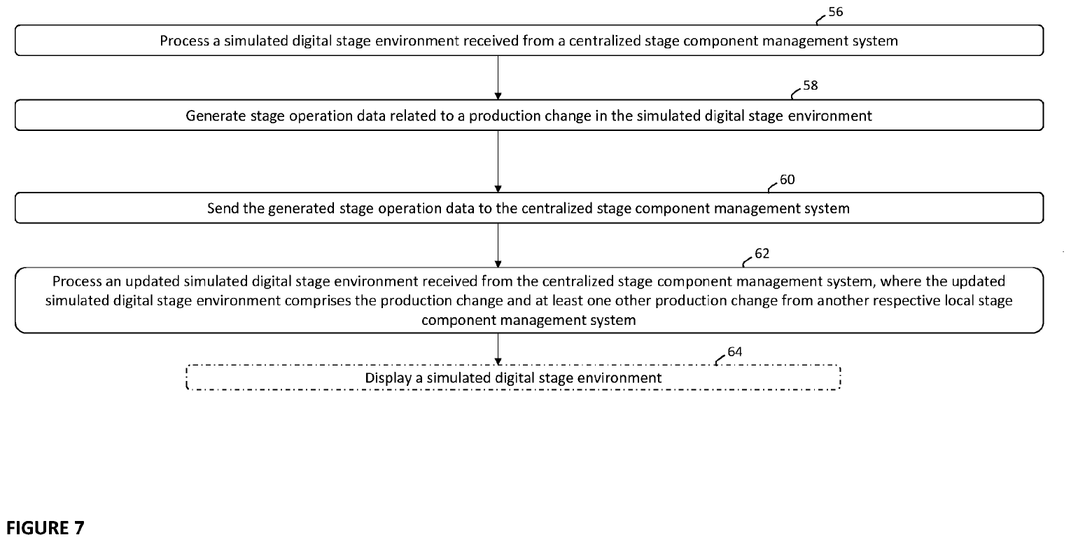

FIG. 7 illustrates a flow diagram depicting example operations which may be taken by the local stage component management systems of FIGS. 1 and 4 as described herein. It should be appreciated that FIG. 7 comprises some operations which are illustrated in a solid border and some operations which are illustrated with a dashed boarder. The operations which are comprised in a solid border are operations which are comprised in the broadest example embodiment. The operations which are comprised in a dashed boarder are example embodiments which may be comprised in, or a part of, or are further operations which may be taken in addition to the operations of the boarder example embodiments. It should be appreciated that these operations need not be performed in order. Furthermore, it should be appreciated that not all the operations need to be performed. The example operations may be performed in any order and in any combination.

Operation 56

The local stage component management system is configured to process 56 a simulated digital stage environment received from a centralized stage component management system. The one or more processing units of FIG. 4 and/or the processing means may be configured to perform operation 56.

Thus, according to such example embodiments, the centralized system SCM_A may receive stage operation data from all of the local nodes in the system SCM_1-SCM_N. Upon coordinating received data, the centralized system SCM_A may update all of the local nodes SCM_1-SCM_N such that all of the local stage component management systems are updated with respect to any stage production changes implemented. Example operation 56 is described at least in relation to FIG. 1.

Operation 58

The local stage component management system is further configured to generate 58 stage operation data related to a production change in the simulated digital stage environment. The one or more processing units of FIG. 4 and/or the generating means may be configured to perform operation 58. Operation 58 is further described under at least the subheadings ‘System Orientation’ and ‘Timeline based Recordation’.

Operation 60

The local stage component management system is also configured to send 60 the generated stage operation data to the centralized stage component management system. The one or more processing units and/or network interface of FIG. 4 and/or the sending means may be configured to perform operation 60.

Operation 60 describes embodiments in which a centralized stage component management system SCM_A is employed. Thus, according to such example embodiments, the centralized system SCM_A may receive stage operation data from all of the local nodes in the system SCM_1-SCM_N. Upon coordinating received data, the centralized system SCM_A may update all of the local nodes SCM_1-SCM_N such that all of the local stage component management systems are updated with respect to any stage production changes implemented. Example operation 60 is described at least in relation to FIG. 1.

According to some of the example embodiments, the stage operation data may be transmitted from a cloud based or an internet based communications medium. Furthermore, according to some of the example embodiments, the centralized node may be configured to receive stage operation data which was generated while a local stage component management system was offline.

Operation 62

The local stage component management system is also configured to process 62 an updated simulated digital stage environment received from the centralized stage component management system. The updated simulated digital stage environment comprises the production change an at least one other production change from another respective local stage component management system. The one or more processing units of FIG. 4 and/or the processing means may be configured to perform operation 62.

Thus, according to such example embodiments, the centralized system SCM_A may receive stage operation data from all of the local nodes in the system SCM_1-SCM_N. Upon coordinating received data, the centralized system SCM_A may update all of the local nodes SCM_1-SCM_N such that all of the local stage component management systems are updated with respect to any stage production changes implemented. Example operation 60 is described at least in relation to FIG. 1.

Example Operation 64

According to some of the example embodiments, the processing 62 may further comprise displaying 64 a playback of the updated simulated digital stage environment. The playback may comprise the production change and the at least one other production change with respect to a timeline. Each production change may be displayed with respect to a time the production change is to occur.

As described under at least the subheading ‘System Orientation’, any of the stage component management systems, in either the centralized or distributed systems, may utilize a simulated digital stage environment. Such a simulation may be useful in previewing stage operations before actually implementing such operations in the stage production. According to some of the example embodiments, in a centralized system, the central stage component management system may be used in maintaining the simulated virtual stage environment for all of the local stage component management systems.

Throughout the description and claims of this specification, the words “comprise” and “contain” and variations of them mean “including but not limited to”, and they are not intended to (and do not) exclude other moieties, additives, components, integers or steps. Throughout the description and claims of this specification, the singular encompasses the plural unless the context otherwise requires. In particular, where the indefinite article is used, the specification is to be understood as contemplating plurality as well as singularity, unless the context requires otherwise.

Features, integers, characteristics, compounds, chemical moieties or groups described in conjunction with a particular aspect, embodiment or example of the invention are to be understood to be applicable to any other aspect, embodiment or example described herein unless incompatible therewith. All of the features disclosed in this specification (including any accompanying claims, abstract and drawings), and/or all of the steps of any method or process so disclosed, may be combined in any combination, except combinations where at least some of such features and/or steps are mutually exclusive. The invention is not restricted to the details of any foregoing embodiments. The invention extends to any novel one, or any novel combination, of the features disclosed in this specification (including any accompanying claims, abstract and drawings), or to any novel one, or any novel combination, of the steps of any method or process so disclosed.

The reader's attention is directed to all papers and documents which are filed concurrently with or previous to this specification in connection with this application and which are open to public inspection with this specification, and the contents of all such papers and documents are incorporated herein by reference.

1. An apparatus for stage production management, comprising:
a network interface configured to receive stage operation data from at least one stage component management system, of a plurality of stage component management systems, representative of a performance of the plurality of stage components in a stage production project, wherein at least two of the stage components relate to a different operation of the stage production project;
a memory unit and one or more processing units configured to:
store in the memory unit received stage operation data from the at least one stage component management system, of the plurality of stage component management systems, wherein each of the received stage operation data comprises an operation of the stage production project and an associated time in which the operation is to occur; and
coordinate all received stage operation data with respect to a timeline of the stage production.

2. The apparatus of claim 1, wherein the apparatus is a central stage component management system, wherein the network interface is further configured to receive stage operation data from all of the stage component management systems in a stage production project, and wherein the one or more processing units is further configured to generate an update message to each of the stage component management systems, wherein the update message comprises a timeline featuring all of the received stage operation data.

3. The apparatus of claim 2, wherein the central stage component management system of a dynamic central node of a master-slave configuration of a distributed network of the plurality of stage component management systems.

4. The apparatus of claim 1, wherein the apparatus is one of the plurality stage component management systems in a distributed configuration, wherein the network interface is further configured to receive stage operation data from all of the other stage component management systems in the stage production project, and wherein the one or more processing units is further configured to generate an update message to each of the stage component management systems, wherein the update message comprises a timeline featuring stage operation data of the apparatus.

5. The apparatus of claim 1, wherein the network interface is further configured to receive the stage operation data from at least two distinct stage component management systems is in a different data format, the one or more processing units is further configured convert or store the received input data in a universal data format.

6. The apparatus of claim 1, wherein the network interface is further configured to receive the stage operation data from a cloud based or an internet based communications medium.

7. The apparatus of claim 1, further comprising a display configured to display a simulated digital stage environment of the stage production, wherein the simulated digital stage environment is configured to playback at least one stage operation data with respect to the timeline.

8. The apparatus of claim 1, wherein the respective aspect of the stage production is related to stage lighting, a movement of an objection on a stage, stage design, chorography, pyrotechnics and/or video processing.

9. A method, in an apparatus, for stage production management, comprising:
receiving stage operation data from at least one stage component management system, of a plurality of stage component management systems, representative of a performance of the plurality of stage components in a stage production project, wherein at least two of the stage components relate to a different operation of the stage production project;
storing in the memory unit received stage operation data from the at least one stage component management system, of the plurality of stage component management systems, wherein each of the received stage operation data comprises an operation of the stage production project and an associated time in which the operation is to occur; and
coordinating all received stage operation data with respect to a timeline of the stage production.

10. The method of claim 9, wherein the apparatus is a central stage component management system, the method further comprising:
receiving stage operation data from all of the stage component management systems in the stage production project; and
generating an update message to each of the stage component management systems, wherein the update message comprises a timeline featuring all of the received stage operation data.

11. The method of claim 9, wherein the apparatus is one of the plurality stage component management systems in a distributed configuration, the method further comprising:
receiving stage operation data from all of the other stage component management systems in the stage production project; and
generating an update message to each of the stage component management systems, wherein the update message comprises a timeline featuring stage operation data of the apparatus.

12. The method of claim 9, further comprising:
receiving the stage operation data from at least two distinct stage component management systems is in a different data format; and
converting or storing the received stage operation data in a universal data format.

13. The method of claim 9, further comprising receiving the stage operation data from a cloud based or an internet based communications medium.

14. The method of claim 9, further comprising displaying a simulated digital stage environment of the stage production, and playing back at least one stage operation data with respect to the timeline.

15. A centralized stage component management system for stage production management, comprising:
a network interface configured to receive stage operation data from at least one local stage component management system, of a plurality of local stage component management systems, representative of a performance of a stage production project, wherein at least two of the local stage component management systems relate to a different aspect of the stage production project;
a memory unit and one or more processing units configured to:
generate a plurality of simulated digital stage environments for a respective local stage component management system, wherein each local stage component management system is located in a respective location;
store in the memory unit received stage operation data from the respective local stage component management systems, wherein different stage operation data from at least two different respective local stage component management systems relate to a different respective aspect of the stage production;
implement production changes in a centralized simulated digital stage environment as a result of the received stage operation data; and
update the plurality of simulated digital stage environments as a result of the implemented production changes.

16. The centralized system of claim 15, wherein the received stage operation data from at least two distinct local stage component management systems is in a different data format, the one or more processing units is further configured convert or store the received stage operation data in a universal data format.

17. The centralized system of claim 15, wherein the one or more processing units is configured to process the stage operation data received from a cloud based or an internet based communications medium.

18. The centralized system of claim 15, wherein the one or more processing units is further configured to implement the production changes with respect to a timeline wherein each production change comprises an associated time in which the production change is to occur.

19. The centralized system of claim 18, wherein the one or more processing units is further configured to display a playback of the centralized simulated digital stage environment, wherein the playback comprises the implemented production changes with respect to the timeline.

20. The centralized system of claim 15, wherein the respective aspect of the stage production is related to stage lighting, a movement of an objection on a stage, stage design, and/or video processing.

21. A local stage component management system for stage production management, comprising:
a memory unit and one or more processing units configured to:
process a simulated digital stage environment received from a centralized stage component management system;
generate stage operation data related to a production change in the simulated digital stage environment;
send the generated stage operation data to the centralized stage component management system; and
process an updated simulated digital stage environment received from the centralized stage component management system, wherein the updated simulated digital stage environment comprises the production change and at least one other production change from another respective local stage component management system.

22. The local stage component management system of claim 21, wherein the one or more processing units is further configured to display a playback of the updated simulated digital stage environment, wherein the playback comprises the production change and the at least one other production change with respect to a timeline, wherein each production change is displayed at a time in which the production change is to occur.

23. The local stage component management system of claim 21, wherein the one or more processing units is configured to process the updated simulated digital stage environment and send the generated input data from and to, respectively, a cloud based or an internet based communications medium.

24. The local stage component management system of claim 23, wherein the one or more processing units is further configured to generate the input data related to the production change while the local stage component management system is offline and send the generated input data to the centralized stage component management system when the local stage component management system returns to an online state.

25. The local stage component management system of claim 21, the production change is related to stage lighting, a movement of an objection on a stage, stage design, and/or video processing.

26. (canceled)

27. (canceled)

28. A method, in a centralized stage component management system, for stage production management, the method comprising:
generating a plurality of simulated digital stage environments for a plurality of local stage component management systems, respectively;
processing stage operation data received from the plurality of local stage component management systems, wherein at least two of the local stage component management systems relate to a different aspect of the stage production project;
implementing production changes in a centralized simulated digital stage environment as a result of the received stage operation data; and
updating the plurality of simulated digital stage environments as a result of the implemented production changes.

29. The method of claim 28, further comprising receiving stage operation data from at least two distinct local stage component management systems is in a different data format, and converting or storing the received stage operation data in a universal data format.

30. The method of claim 28, further comprising processing the stage operation data received from a cloud based or an internet based communications medium.

31. The method of claim 28, further comprising implementing the production changes with respect to a timeline wherein each production change is associated with a time in which the production change is to occur.

32. The method of claim 31, further comprising displaying a playback of the centralized simulated digital stage environment, wherein the playback comprises the implemented production changes with respect to the timeline.

33. The method of claim 28, wherein the respective aspect of the stage production is related to stage lighting, a movement of an objection on a stage, stage design, and/or video processing.

34. A method, in a local stage component management system, for stage production management, the method comprising:
processing a simulated digital stage environment received from a centralized stage component management system;
generating stage operation data related to a production change in the simulated digital stage environment;
sending the generated stage operation data to the centralized stage component management system; and
processing an updated simulated digital stage environment received from the centralized stage component management system, wherein the updated simulated digital stage environment comprises the production change and at least one other production change from another respective local stage component management system.

35. The method of claim 34, further comprising displaying a playback of the updated simulated digital stage environment, wherein the playback comprises the production change and the at least one other production change with respect to a timeline, wherein each production change is displayed with respect to a time the production change is to occur.

36. The method of claim 34, further comprising receiving the updated simulated digital stage environment and sending the generated stage operation data from and to, respectively, a cloud based or an internet based communications medium.

37. The method of claim 36, further comprising generating the stage operation data related to the production change while the local stage component management system is offline and sending the generated stage operation data to the centralized stage component management system when the local component management system returns to an online state.

38. The method of claim 34, wherein the production change is related to stage lighting, a movement of an objection on a stage, stage design, and/or video processing.

39. A centralized stage component management system for stage production management, comprising:
generating means for generating a plurality of simulated digital stage environments for a plurality of local stage component management systems, respectively;
processing means for processing stage operation data received from respective local stage component management systems, wherein stage operation data from at least two different respective local stage component management systems relate to different aspects of the stage production;
implementing means for implementing production changes in a centralized simulated digital stage environment as a result of the received stage operation data; and
updating means for updating the plurality of simulated digital stage environments as a result of the implemented production changes.

40. The centralized system of claim 39, further comprising receiving means for receiving the stage operation data from at least two distinct respective users is in a different data format, and converting means for converting or storing the received stage operation data in a universal data format.

41. The centralized system of claim 39, wherein the processing means is further configured to process the stage operation data received from a cloud based or an internet based communications medium.

42. The centralized system of claim 39, wherein the implementing means is further configured to implement the production changes with respect to a timeline wherein each production change is associated with a time in which the production change is to occur.

43. The centralized system of claim 42, further comprising a displaying means for displaying a playback of the centralized simulated digital stage environment, wherein the playback comprises the implemented production changes with respect to the timeline.

44. The centralized system of claim 39, wherein the respective aspect of the stage production is related to stage lighting, a movement of an objection on a stage, stage design, and/or video processing.

45. A local stage component management system for stage production management, comprising:
processing means for processing a simulated digital stage environment received from a centralized stage component management system;
generating means for generating stage operation data related to a production change in the simulated digital stage environment;
sending means for sending the generated stage operation data to the centralized stage component management system; and
the processing means further configured for processing an updated simulated digital stage environment received from the centralized stage component management system, wherein the updated simulated digital stage environment comprises the production change and at least one other production change from another respective local stage component management system.

46. The local system of claim 45, further comprising a displaying means for displaying a playback of the updated simulated digital stage environment, wherein the playback comprises the production change and the at least one other production change with respect to a timeline, wherein each production change is displayed with respect to a time the production change is to occur.

47. The local system of claims 45, further comprising a receiving means for receiving the updated simulated digital stage environment and the sending means further configured to send the generated stage operation data from and to, respectively, a cloud based or an internet based communications medium.

48. The local system of claim 47, further comprising generating means to generate the stage operation data related to the production change while the local processor is offline and sending the generated input data to the centralized stage component management system when the local stage component management system returns to an online state.

49. The local system of claim 45, wherein the production change is related to stage lighting, a movement of an objection on a stage, stage design, and/or video processing.

50. A computer-readable medium comprising executable instructions such that when executed by a centralized stage component management system provide for a stage production management system to:
generate a plurality of simulated digital stage environments for a plurality of local stage component management systems, respectively;
process stage operation data received from the respective local stage component management systems, wherein at least two stage operation data from at least two different respective local stage component management systems relate to different aspects of the stage production;
implement production changes in a centralized simulated digital stage environment as a result of the received stage operation data; and
update the plurality of simulated digital stage environments as a result of the implemented production changes.

51. The computer-readable medium of claim 50, wherein the received stage operation data from at least two distinct respective local stage component management systems is in a different data format, the instructions further provide for the stage production management system to convert or store the received stage operation data in a universal data format.

52. The computer-readable medium of claim 50, wherein the instructions further provide for the stage production management system to process the stage operation data received from a cloud based or an internet based communications medium.

53. The computer-readable medium of claim 50, wherein the instructions further provide for the stage production management system to implement the production changes with respect to a timeline wherein each production change is associated with a time in which the production change is to occur.

54. The computer-readable medium of claim 53, wherein the instructions further provide for the stage production management system to display a playback of the centralized simulated digital stage environment, wherein the playback comprises the implemented production changes with respect to the timeline.

55. The computer-readable medium of claim 50, wherein the respective aspect of the stage production is related to stage lighting, a movement of an objection on a stage, stage design, and/or video processing.

56. A computer-readable medium comprising executable instructions such that when executed by a local stage component management system provide for stage production management system to:
process a simulated digital stage environment received from a centralized stage component management system;
generate stage operation data related to a production change in the simulated digital stage environment;
send the generated stage operation data to the centralized stage component management system; and
process an updated simulated digital stage environment received from the centralized stage component management system, wherein the updated simulated digital stage environment comprises the production change and at least one other production change from another respective local stage component management system.

57. The computer-readable medium of claim 56, wherein the instructions further provide for the stage production management system to display a playback of the updated simulated digital stage environment, wherein the playback comprises the production change and the at least one other production change with respect to a timeline, wherein each production change is associated a time in which the production change is to occur.

58. The computer-readable medium of claim 56, wherein the instructions further provide for the stage production management system to process the updated simulated digital stage environment and send the generated stage operation data from and to, respectively, a cloud based or an internet based communications medium.

59. The computer-readable medium of claim 58, wherein the instructions further provide for the stage production management system to generate the stage operation data related to the production change while the local stage component management system is offline and send the generated stage operation data to the centralized stage component management system when the local stage component management system returns to an online state.

60. The computer-readable medium of claim 56, the production change is related to stage lighting, a movement of an objection on a stage, stage design, and/or video processing.

61. (canceled)

62. (canceled)

63. (canceled)

64. (canceled)
